(19) United States
(12) Patent Application Publication
(10) Pub. No.: US 2005/0141503 A1
(43) Pub. Date: Jun. 30, 2005

(54) Distriuted packet processing system with internal load distributed

(76) Inventor: Feliks J Welfeld, Ontario (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/493,873

(22) PCT Filed: May 16, 2002
(86) PCT No.: PCT/CA02/00715

Related U.S. Application Data
(60) Provisional application No. 60/291,332, filed on May 17, 2001.

(51) Int. Cl. H04L 12/28

(52) U.S. Cl. 370/392; 370/412

(57) ABSTRACT

A programmable packet processing system is disclosed wherein a lower speed processor is used to process higher speed data. The system comprises a plurality of packet processor “cores”, for serial connection one to another. Data packet arbitration is performed by each processor in sequence such that packets for processing by a processor are not passed on down the serial pipeline and those that are not for processing by a present processor are passed downstream. The pipeline also includes an ordering circuit for ensuring that processed packets are provided to an output of the pipeline in the order they are received.

### FIELD OF THE INVENTION

The invention relates to packet processors and more particularly to parallel pipeline packet processors for use in high-speed communication.

### BACKGROUND OF THE INVENTION

A current area of research in packet processor design is the area of digital communications. Commonly, in digital communication networks, data is grouped into packets, cells, frames, buffers, and so forth. The packets, cells or so forth contain data and processing information. It is important to process packets, cells, etc. for routing and correctly responding to data communications. For example, one known approach to processing data of this type relies on a state machine.

For high-speed data networks, it is essential that a packet processor operate at very high speeds to process data in order to determine addressing and routing information as well as protocol-related information. Unfortunately, at those speeds, memory access is a significant bottleneck in implementing a packet processor or any other type of real time data processor. This is driving researchers to search for innovative solutions to increase processing performance. An obvious solution is to implement a packet processor completely in hardware. Non-programmable hardware processors are known to have unsurpassed performance and are therefore well suited to higher data rates; however, the implementation of communication protocols is inherently flexible in nature. A common protocol today may be all but obsolete in a few months. Therefore, it is preferable that a packet processor for use with high-speed data networks is programmable. In the past, solutions for 10 Mbit and 100 Mbit Ethernet data networks were easily implemented with many memory access instructions per byte being processed in order to accommodate programmability. This effectively limits operating speeds of the prior art processors. Further, with speeds increasing to many Gigabit rates, even fast electronic processors are difficult to design for supporting these data rates in packet processing.

One method of passing more data through a slower system is using a parallel architecture. Accordingly, it is possible to implement a plurality of processors in parallel each having a different program memory. Thus, the memory access bottleneck is obviated. Packets from an input data stream are distributed amongst processors in a round robin fashion. Each processor processes a provided data packet and provides a result on a packet processing signal. Such a system appears beneficial but is actually plagued by several known problems. First, every packet does not require equal resources to be processed. Therefore, simply dividing up the packets among the processors likely lead to unnecessary overflow conditions in some of the processors unless the buffers are very large. If an overflow occurs, data is lost and some packets may be incorrectly processed or fail to be processed. Secondly, packet processor results are provided from parallel engines in an order somewhat unrelated to the order in which the packets exist within the input data stream.

It would be advantageous to provide a modular packet processor architecture for a processor of packet data stream that supports high-speed data streams, uses cost effective buffers, and is expandable.

### OBJECT OF THE INVENTION

In order to overcome these and other limitations of the prior art, it is an object of the invention to provide a packet processor architecture for supporting parallel processing of packets and expansible programmable high speed packet processing.

It is another object of the present invention to provide a packet processor architecture for supporting parallel implementation of high speed packet processing for one or more data streams.

### STATEMENT OF THE INVENTION

In accordance with the invention there is provided a packet processor comprising:
a plurality of packet processor sub-engines each comprising:
   a data input buffer for receiving a stream of input data and for buffering data within the stream relating to packets to be processed by the sub-engine,
   a packet processor core for receiving buffered stream data from the data input buffer, for processing the buffered stream data relating to a single packet, and for providing processor results relating to the single packet, and,
   an output buffer for receiving the processor data and for buffering the received processor data and for providing the buffered data at an output port thereof in response to a control signal;
an input buffer controller for providing control signals to the input buffers from different packet processing sub-engines, the signals indicative of packets for buffering and processing by each packet processing sub-engine; and,
an output buffer controller for providing the control signals to the output buffers from different packet processing sub-engines.

According to another embodiment of the invention, a packet processor is provided comprising:
a plurality of packet processing cores, each for receiving buffered stream data, for processing a packet within the buffered stream data provided to the packet processing core, and for providing processing data relating to the processed packet;
a data input buffer for receiving a stream of input data, for buffering data within the stream relating to packets to be processed by the packet processor, for determining a packet processing core from the plurality of packet processing cores having available bandwidth, and for providing the buffered stream data to the determined packet processing core from the plurality of packet processing cores;
an output buffer for receiving the processing data from each of the packet processing cores and for providing the processing data at an output port thereof in an order similar to that in which the packets are received within the input data stream.

According to another embodiment of the invention, a packet processor module is provided having at least a packet processing sub-engine. The packet processing sub-engine includes a data input buffer for receiving a stream of input data and for buffering data within the stream relating to packets to be processed by the sub-engine, a packet processing core for receiving buffered stream data from the data input buffer, for processing the buffered stream data relating to a single packet, and for providing processing data relating to the single packet, and, an output buffer for receiving the processing data and for buffering the received processing data and for providing the buffered data at an output port thereof in response to a control signal. The module also includes an input buffer controller for in the master mode providing control signals to the input buffers from another packet processing module in communication with the packet processing module, the signals indicative of packets for buffering and processing by the other packet processing module; and an output buffer controller for, in the master mode, providing the control signals to the output buffers from another packet processing module in communication with the packet processing module. In a slave mode, the controllers are disabled or, alternatively, operate to provide control signals to buffers within their module in response to master control signals from a master buffer controller.

According to the invention there is also provided a method of processing packets comprising the steps of providing a stream of data including packet data. Formatting the received data stream by providing sequencing information relating to a sequence of packets within the data stream. Determining packets for processing in a current module and providing same to the current module for packet processing. Providing remaining packets to downstream modules for processing thereby. Also providing to downstream modules processed packets, their associated packet processing data, and associated sequencing data such that a module most downstream will provide at its output in a correct sequence processed packet data.

### BRIEF DESCRIPTION OF THE DRAWINGS

An exemplary embodiment of the invention will now be described in conjunction with the attached drawings, in which:

FIG. 1 is a simplified block diagram of a packet processor according to the prior art;

FIG. 2 is a simplified block diagram of a multi-chip processor using cascaded packet processing modules;

FIG. 3 is a simplified block diagram of a single packet processing module for use within a cascade;

FIG. 4 is a diagram showing a queue structure for use with the present invention;

FIG. 5 is a simplified timing diagram relating to data realignment when the embodiment of FIG. 2 is implemented;

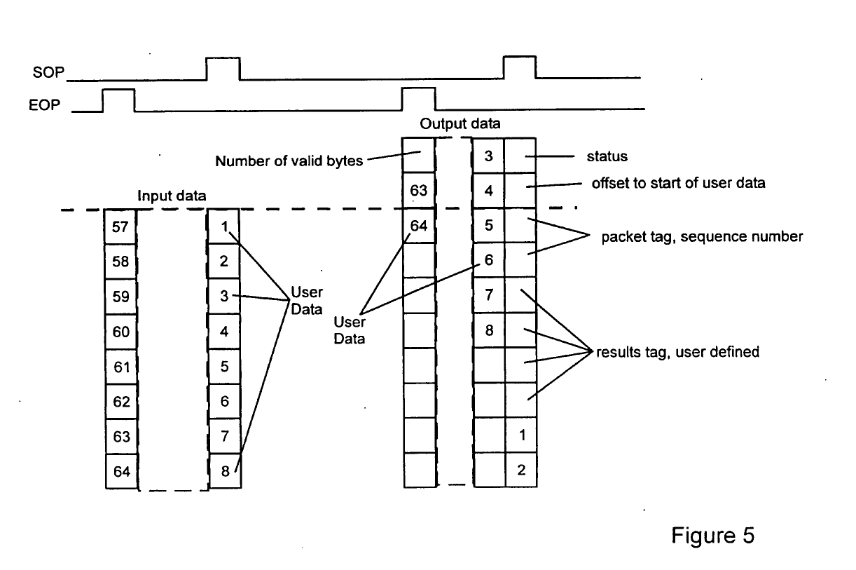

FIG. 6 is a simplified architectural overview of another module architecture;

FIG. 7 is a simplified block diagram presenting an overview of processor operation for the module of FIG. 6; and,

FIG. 8 is a simplified block diagram of an integrated circuit for implementing a module according to FIG. 6.

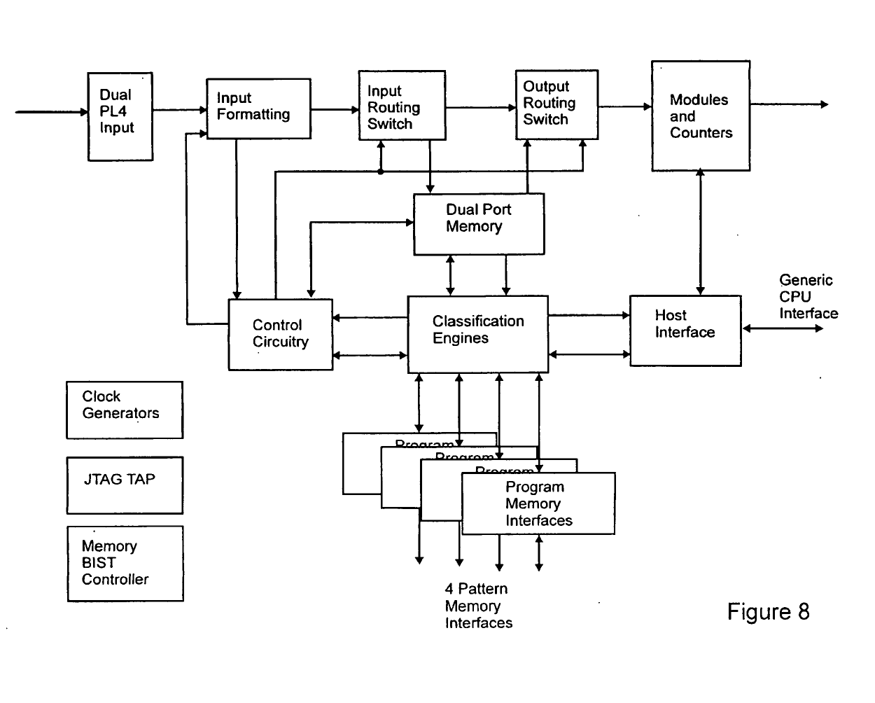

### DETAILED DESCRIPTION OF THE INVENTION

As used herein, the term “data packet” encompasses the terms buffer, frame, cell, packet, and so forth as used in data communications. Essentially a data packet is a grouping of data that is classifiable according to a predetermined processing. Classification is commonly codified by standards bodies, which supervise communication standards.

The term “channels” refers to concurrent or simultaneous and often independent processing processes that a packet processor executes.

The term “packet processor” or “engine” refers to an electronic circuit or the like for receiving packet data and for analysing the packet data to classify the packet data according to a predetermined set of rules.

The term “port” refers to a physical port for receiving a physical signal containing at least a logical data stream. The term “channelized” used in the POSPHY PL4 interface definition which is publicly available also refers to individual streams or flows that time share the OC192 physical attachment. Generally herein, these are all referred to as ports.

The terms upstream and downstream are used herein in relation to stream data flow. The first module receives the stream data from a transceiver circuit or the like. The last module provides processed data at an output thereof. An intermediate module is said to be downstream of the first module but upstream of the last module. As such, stream data flows from the first module to an intermediate module and finally to the last module.

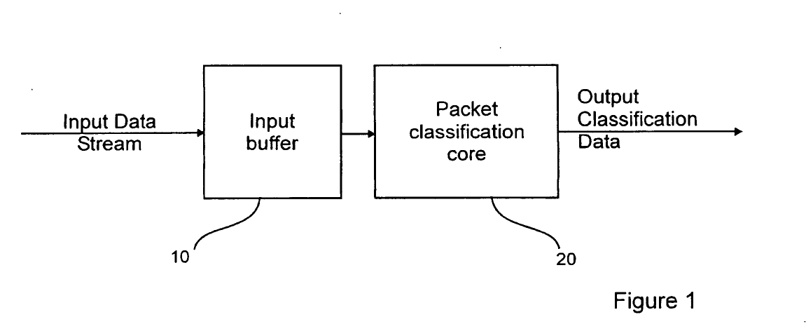

Referring to FIG. 1 a simplified block diagram of a typical processing state machine according to the prior art is shown. An input data stream is received. It is buffered in the buffer 10. From the buffer 10, the data is provided to a packet processing core 20. The buffer 10 acts to store data so that the processing core need not meet stringent timing requirements and can query subsequent data when ready and as needed. Some of the data is not used in packet processing and as such, this data can be skipped by moving through the buffer to a next location having pertinent data. Thus, the processor need only provide processing capabilities sufficient to account for overhead and analysing data relating to packet processing. Similarly, the input buffer 10 need only store sufficient data that an overflow does not occur. If an overflow occurs, data will be lost and some packets may be incorrectly processed or fail to be processed.

When the processing core has a speed that supports data rates higher than the data rate of the input data stream, buffer overflow is unlikely. As the core speed is reduced relative to the input data stream, a risk of buffer overflow increases. For example, when the buffer within the core operates at half the stream speed, a number of processing intensive packets one after another often results in a data overflow. The use of larger buffers is undesirable since, for very high-speed data streams, large buffers are costly.

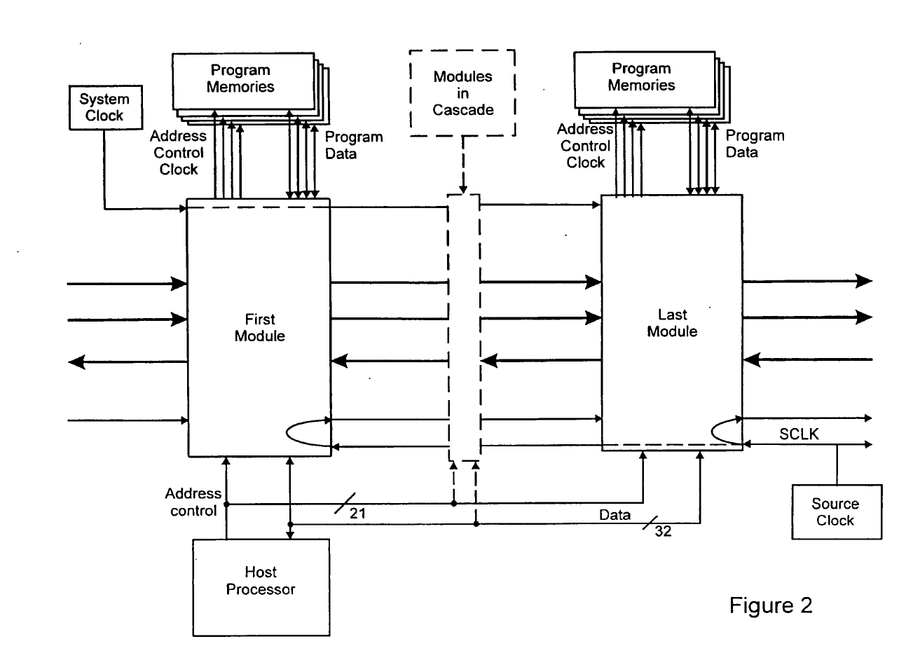

Referring to FIG. 2, a simplified block diagram of another embodiment of the present invention is shown. Here, instead of arranging the packet processing modules in parallel, they are cascaded. Even though their physical arrangement is in series, the modules act to process packet data in parallel.

In the diagram of FIG. 2, two packet processing modules are shown with an unknown number of further packet processing modules disposed therebetween. The modules are cascaded one after another. Each packet processing module is in communication with processing memory dedicated to that module. Each module is identical allowing for an easily expandable and flexible architecture that benefits from the cost savings of larger volumes. The modules shown each have a high bandwidth high data rate data stream port for receiving and propagating data in a downstream direction and another two lower bandwidth lower data rate data ports for receiving and providing data in an upstream direction relating to module status.

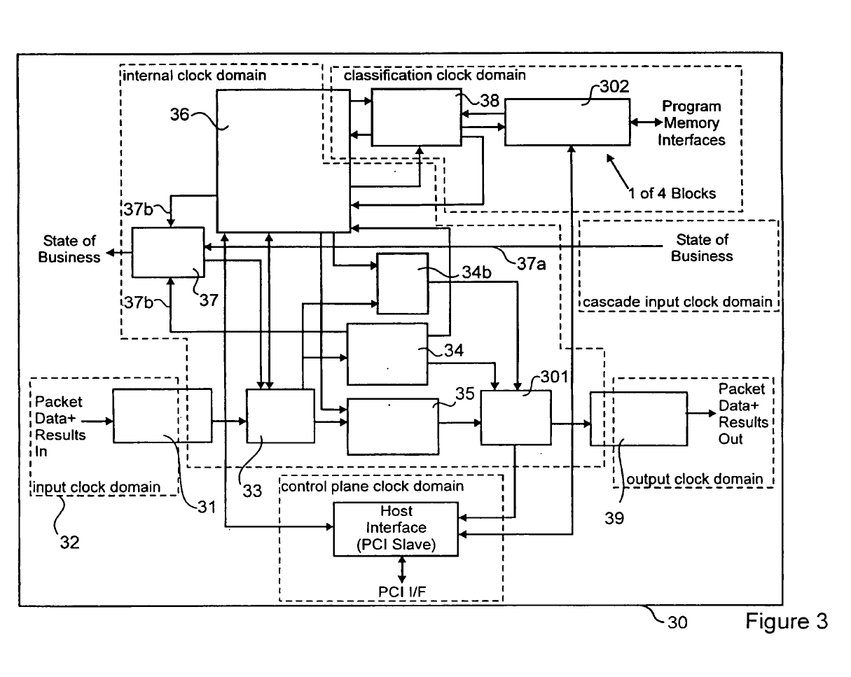

Referring to FIG. 3, a simplified block diagram of a single module is shown. Packet data is received at an external physical interface by an Input Packet Interface 31. It is shown within a dashed line 32 representing an input clock domain. The received data is buffered into fragments and converted to serial data at the internal clock rate using dual-clocked FIFO's within the Input Packet Interface 31. The packet data fragments are then read by a Packet Receive Controller 33 and stored in a Packet Data Buffer 34. The Packet Receive Controller 33 includes circuitry for deciding whether or not the received packet is forwarded to a subsequent module in a cascade for processing or is locally processed in the form of classification processing. If the packet is for processing by the module 30, a new packet is enqueued on a Classification Queue within Classification, Pre-Classified and Bypass Queues 35 and registered with a Packet Processing Controller 36.

For a situation where modules are arranged in a cascading fashion, the decision as to where to process a data packet is made in a Cascade Manager 37, which makes a decision based on the state of business information—state of classifiers empty and data buffer utilization—received from a down stream module 37a and its local state of business information 37b. The Packet Receive Controller 33 stores packet data in the Packet Data Buffer 34 and accessible using pointers assigned and linked. As packets fragments arrive, data store is allocated within the buffer and accessible via pointers that are then linked and registered with the Packet Processing Controller 36. The Packet Data Buffer 34 is composed of a pool of fragments (64) byte buffers together with a block of buffer pointer descriptors.

Once the decision to locally classify or forward a packet has been made, the incoming packet is enqueued to the appropriate queue—Classification, Bypass or Pre-classified—within the queues 35. The simplest queue from a control perspective is the Bypass Queue. It is a FIFO based queue and has priority over the Classification Queue. The Classification Queue is more complex and requires that packets be dequeued only once classification is complete and ordering is correct. It is worth noting that the behavior of the input packet interface 31, the classification queue and the output packet interface 39 vary depending on the location of the module within a cascade.

The state of business interfaces support communication of the state of business from one module to another in a cascade of modules in an upstream direction. There are two SOB interfaces one in from the downstream module in the cascade and one out to transmit the state of business to the upstream module in the cascade. The SOB is also useful for determining a position of the module within the cascade, first, last or middle. The signal requires very little bandwidth and merely has to indicate a most available state of business downstream. Thus, each module determines its state of business and, if it is more available than the state of business signal received, it replaces the received signal with its own state of business. Similarly, a module need only determine if its state of business is more available than the state of business it receives from downstream to determine whether a received and unclassified packet of data is to be classified therein or bypassed to modules downstream thereof. In order to ensure that a last module does not pass unclassified packets of data downstream thereof for processing, a state of business signal is provided thereto indicating no availability downstream thereof.

The Packet Processing Controller 36 controls processing of packets. It schedules engines within the Classification Engines 38 and tracks packets by maintaining unique packet identifiers. Every time a packet fragment for a packet that is being classified within the module 30 arrives, the Packet Processing Controller 36 is notified so that it can schedule the packet fragment to be processed by a next available Classification Engine 38. Classification results are placed into the Results Data Buffer 34b. An allocated Result Data Buffer pointer is passed to the Packet Transmit Controller 301 when classification is completed. From there the Packet Transmit Controller 301 pre appends data from the result buffer 34b to the appropriate packet with which the result is associated.

The Packet Transmit Controller 301 monitors the Classification, Bypass and Pre-classified queues 35. When the Bypass Queue has a pending packet the Packet Transmit Controller 301 dequeues it by reading the pointer on the queue, formats the read data and forwards the packet via the Output Packet Interface 39. As stated earlier the data format varies depending on the position of the module 30 within the cascade. As bypass buffers are read and data therefrom is forwarded, stale buffer pointers are returned to the free pool for reused.

The Packet Receive Controller 33 in a first module in a cascade has an additional function of tagging the packets with a unique sequence number within a channel. All other modules within the cascade receive the packets pre-tagged.

The Packet Receive Controller 33 keeps track of pre-classified packets and routes these to the Pre-classified Queue for transmission downstream of the module. For the first module in the cascade none of the received packets are pre-classified. The Packet Receive Controller 33 optionally knows whether a received unclassified packet is to be classified locally or not so as to store the packets in a different memory in the Packet Data Buffer 34. This additional function in the Packet Receive Controller 33 is dependent on how the Packet Data Buffer 34 is implemented.

Specifically, the Packet Receive Controller 33 of the first module within a cascade performs the following steps: determines, based on the state of business 37a and 37b, whether to classify each received packet locally or bypass it; assign an initial sequence number, stored in the state variable “seq_num”, and command/status bits to each received packet; increment the sequence num; store the sequence number and command/status information in the Bypass or Classification queue, depending on the state of business 37a and 37b; and register the packet in a Sequence Assignment Queue.

The command and status bits may be set to indicate a pattern memory reload or a sequence number reset. The pattern memory reload indication originates from pattern memory controller 302. Typically, packet data in the Packet Data Buffer 34 has no information pre-pended to it.

The Packet Receive Controller 33 in subsequent modules within the cascade performs the following steps: determines which queue into which to place a packet—if the packet is already classified, as indicated within the packet data, then place it in the Pre-Classified Queue or otherwise, assign either the Classification or Bypass queue depending on the state of business; copy the sequence number and command/status bits from the first word of packet data to the appropriate queue—packet data in the Packet Data Buffer represents the packet as received by the Packet Receive Controller 33 and includes tag and digest information.

Under no circumstance is the Packet Receive Controller 33 responsible for modifying the contents of the packet as it is stored in the Packet Data Buffer 34. Alternatively, the packet receive controller 33 does modify packet data. Modifications are necessary to insert the sequence, tag and digest information, but this is typically the responsibility of the Packet Transmit Controller 301.

The Cascade Manager 37 optionally is provided with circuitry for transmitting information downstream to subsequent modules within the cascade. For example, when the pattern memory is reloaded, an indication of the reprogramming is sent from the first module downstream to each module within the cascade, so that all modules are informed of when the old pattern memory programming is no longer to be used. To support this function, the Packet Receive Controller 33 has an interface to the Cascade Manager 37. This interface works as follows:
When an indicator is provided, the Packet Receive Controller 33 constructs a packet as follows: error flag: false, EOP: true, SOP: true, number of bytes in fragment: 4, channel number: taken from the indicator, and data: taken from the indicator. This packet fragment is switched into the data path coming from the Input Packet Interface 31. Once the data word is transferred, a done indicator is provided for one clock cycle to acknowledge the data transfer. The Packet Receive Controller 33 then proceeds to inject this packet, placing it in the Pre-Classified Queue. As such, it is passed downstream on a lower priority basis to provide for downstream communication without requiring another I/O from each module.

With each module, there is a corresponding memory. Typically, this memory is external to reduce module complexity. Optionally, the memory is internal to the module. Of course, when a single module incorporates a plurality of different processing cores, it is preferable to have several different processing memories corresponding to a single module.

Alternatively, some modules within a cascade are different one from another but support functions necessary to achieve the present architecture. For example, a first module supports packet tagging while all subsequent modules are absent packet tagging circuitry. Of course this reduces the benefit of production scale since two modules are required instead of one. Also, the circuitry required to tag the packets is not considered significantly costly and, as such, it is preferred that each module have same functionality.

For fragment processing, packet reconstruction is either performed prior to processing or partial processing is supported. Tagging functions of the Packet Receive Controller 33 support packet reconstruction and ensure that fragmenbts of a same packet are similarly tagged to ensure that all fragments of one packet are directed to a same module for classification thereby.

The Classification, Pre-Classified, and Bypass Queues 35 contain three queues. Typically, the queues are maintained with pointers while the actual stored data is stored within a same queue. Thus, though three queues are described below, these are typically logical queues using a physical memory circuit or mirrored physical memory circuits.

The Packet Data Bypass Queue holds descriptors for the packets to be sent downstream in a cascade of modules. The last module in the cascade will have an unused Bypass Queue or, alternatively, be absent the bypass queue. All data packets arriving at the last module are either pre-classified or to be classified on this module. There is no need to sort packet ordering per channel for the Bypass Queue since packets therein arrive and are propagated in order. Typically, the Bypass Queue contents are high priority to ensure that data reaches a processing module therefore as soon as possible.

The Bypass queue only has to be large enough to handle a worst case flow control period plus the input port to output port latency. This is because this queue has priority on transmission at the output port. The Bypass Queue is used to buffer packet descriptors for packets which are stored in the Packet Data Buffer 34 but not classified on the present module while they wait to be forwarded downstream. A single bypass queue for all channels is typical, though other implementations are possible. However, if there is only one queue then packet fragments have to be queued.

The Pre-classified Queue holds packet descriptors for data packets that have been classified by an upstream module within the cascade. The first module in the cascade does not need this queue because no pre-classified packets arrive in the input data stream thereto. Preferably, all pre-classified packets arrive in order obviating a need for sorting packet ordering per channel for the Pre-classified queue. A separate queue for each channel in this queue is typically necessary to allow for per channel flow control and to maintain classified per channel packet ordering on the output port. Preferably, the pre-classified queue is large enough to handle the worst case delay.

The Classification Queue stores packet descriptors for packets to be classified on a current module. All modules within a cascade have this queue because each module processes a portion of the incoming packets. There is no need to sort packet ordering per channel for the classification queue since all unclassified packets arrive in order. The packets destined for classification on a module are enqueued in the order that they arrive. For the channelised case a separate queue for each channel is necessary to maintain classified packet ordering per channel on the output port. In the case of a single non-cascaded module, a single queue is usable for holding all the packet descriptors for packet data for classification. This queue is preferably large enough to handle enough packet descriptors for the worst case delay, which would be a single MAX size packet followed by continuous MIN size packets.

Preferably, The classification queue is compile time configurable for the following items: the number of queues (channels), 1 to 256; the width of the packet descriptor information; and the depth of the Packet Descriptor Memory, # of queue elements, shared between all channel queues.

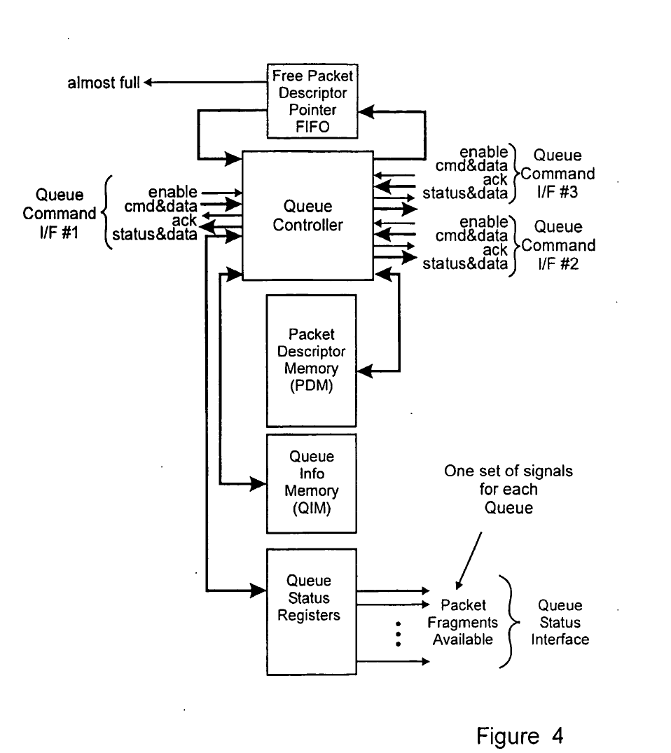

Referring to FIG. 4, the classification queue structured is shown. A Queue Controller is for initializing a Free Packet Descriptor Pointer FIFO. It is also for executing commands presented at Queue Command Interfaces. The Free Packet Descriptor pointer FIFO stores pointers to free packet descriptors in the Packet Descriptor Memory. A Queue Info Memory is for having stored therein queue information including head and tail pointers, an empty flag, cashed packet descriptors of first packets in each channel's queue, and user defined information if any. A Packet Descriptor Memory is for having stored therein packet descriptors of all queued packets. A plurality of Queue Status Registers, one for each queue, is provided each including at least a single bit indicating that the per-channel queue has fragments available for transmission therefrom.

Each per-channel queue provides an indication to the Packet Transmit Controller 301, using the Pcq_Ptc_eligible signals, that a packet is eligible for transmission. The Packet Transmit Controller 301 arbitrates among those queues that are indicated as eligible. The Bypass and Pre-Classified Queues are eligible when they are non-empty, and the packet at the head of the queue has two or more fragments or has only one fragment which is the end of packet. The Classification Queue is eligible if, in addition to the requirements for the Pre-Classified Queue, the packet at the head of the queue has been classified. The mark_classified( ) command provides this indication. After the command, eligibility is recomputed. In the descriptions above, the function “update_eligible (q_id, qi)” is expanded as:
if qi.empty then eligible=false
else
if qi.cache.frag_count=0 then eligible=false
else if qi.cache.frag_count=1 && !qi.cache.EOP then eligible=false
else if CLASSIFICATION and qi.cache.EOC=0 then eligible=false
else eligible=true

The queue updates its eligibility status in response to commands submitted to it, so that the Packet Transmit Controller 301 operates without polling the queues. Every command that modifies a queue potentially changes the eligibility status. Commands that would otherwise operate on a packet descriptor only may affect the eligibility if the given descriptor happens to be at the head of the queue. To determine if this is the case, all queue modification commands take the channel number as an argument, so that the queue descriptor can be read in.

The computation of eligibility requires a finite non-zero number of clock cycles, for example 3. However, the arbiter in the Packet Transmit Controller 301 may sample the eligibility value at any time. For this reason, the queue must de-assert (mask) the eligibility indication for any cycles following a command to dequeue until the elegibility is recomputed. This is easily achieved, for example using a small shift register for each channel. Note that the Pre-Classified and Classification Queues may both be eligible for transmission according to the above criteria, which do not take sequence ordering into account. Sequence ordering is performed using the Sequence Assignment Queue, described below.

The Sequence Assignment Queue is an alternative to the Bypass Marker Queue. The Sequence Assignment Queue takes a different logical approach. Rather than storing the next sequence number for each queue and having the queue logic determine the source of the next packet, the Sequence Assignment Queue keeps track of which queue a packet is in, on a sequence number basis. By storing multiple sequence assignments in a single memory word, and exploiting the contiguous nature of per-channel sequence numbers, the Sequence Assignment Queue is able to determine the source of a next ordered packet in near-constant time.

Note that although in an embodiment the Sequence Assignment Queue stores information for all packets, it prescribes treatment (i.e. transmission order) only for “ordered” packets: those that are in either the Classification or Pre-Classified queues. Bypassed packets are given priority in the Packet Transmit Controller 301 and are typically not affected by the operation of the Sequence Assignment Queue.

The function of the Packet Transmit Controller 301 is to transfer data buffered in the Packet Data Buffer 34 and the Results Data Buffer 34b to the Output Packet Interface 39 for transmission out of the module. The Packet Transmit Controller 301 services the Bypass, Pre-classified and Classification queues 34. These queues contain per channel packet descriptors—pointers to Packet Data Buffer 34 and Results Data Buffer 34b—and status signals that indicate if there is packet data for a particular channel for transmission to the output port. The Bypass Queue is given priority over the other queues. If there is data from any channel on the Bypass Queue the Packet Transmit Controller reads the data pointed to in the Packet Data Buffer 34 by the Bypass Queue descriptor and provides it to the Output Packet Interface 39. If there is no data ready in the Bypass Queue then the Packet Transmit Controller 301 services the Pre-classified and Classification Queues.

The packets per-channel from the Pre-classified and Classification Queues are transmitted in the same order as they arrived at the first module within the cascade. To achieve this, each channel maintains as part of its state a sequence number of the next packet to be transmitted. This sequence number is sent to the Sequence Assignment Queue, which determines from which queue the next ordered packet should be retrieved.

The inventive module tags and classifies packets. The packet tagging is preferably done only by a first module within a cascade. The packet tagging is used to mark the status of a packet, send information to the next module in a cascade and identify the packet with a unique sequence number to preserve packet ordering within a channel. Classification Results are produced by the module in the cascade that classifies the packet. The Classification Result information is appended to the packet. The most downstream module need not provide the tag information from the output thereof other than the classification data therein.

In a cascade the synchronization of the packet sequence numbers is done using the SOP packet to send a sync command, the first module in the cascade sends this command to the other modules in the cascade.

In accordance with an embodiment, every packet entering the classification cascade is tagged with a unique sequence number. This sequence number is effectively a time stamp identifying packet order. This stamp is used to maintain packet emission order from the cascade. By practical limitations the range of the sequence counter is limited and eventually wraps around—resulting in non-unique sequence numbering. If not compensated, the wrapping could destroy the packet order. To overcome this limitation the sequence number is divided into time zones and a tag. When a packet arrives the contents of the sequence counter are attached to the packet. When the packet is processed its time zone portion of the tag is adjusted by adding the compliment of the current time zone of the sequence counter.

The sequence number system assumes that all packets have unique tags. An aging process is used to insure stale packets are purged from the cascade. Secondly, the sequence number system also assumes that the sequence counters of all the modules in the cascade are synchronized to the cascade's first module. At power up or after a reset, synchronization is performed to ensure that intermodule synchronization exists.

The changing of classification processes is done in a controlled manner to ensure that packets are classified properly and Pattern Memory associated with the classification process are recoverable and re-usable. In a cascade of modules the switching of classification processes is preferably done at one point in the packet flow for all modules in the cascade. The following steps describe a procedure for changing the classification process that achieves the above noted features.

1. Store a new classification process in all Pattern Memories.

2. Update the inactive bank of ISR information pointing to the new classification process.

3. Wait for acknowledge that all Pattern Memories and ISR updates have been done in all modules in the cascade of modules.

4. Switch in ISR banks that contain the new classification process at the next SOP in the packet. Send a switch ISR bank command in the next bypassed packet so that the change takes place at the same packet boundary in each module within the cascade of modules.

5. When the old classification process is no longer use, the Pattern Memory associated with it is recovered and reusable.

The previous steps imply that there is upstream feedback on Pattern Memory writes and ISR information throughout the cascade. Also, a mechanism for knowing when the old classification process is no longer in use is required. It is preferable to only write to the Pattern Memory and ISR in the first module within the cascade and then have the data propagate downstream within the cascade with an acknowledge back when the storing is completed. Further preferably, ISR changes are made at a same packet boundary within all modules requiring that the action to switch in the new ISR originates at the first module in the cascade and a sync signal sent with the next SOP packet downstream through the cascade is used to initiate the new ISR. Further preferably, a version number for ISRs, initially set by the host and incremented by hardware is provided. The version number allows identification of an ISR and that it has been transmitted to the last module in the cascade. When this is the case, all previous ISR version numbers are no longer in use and the Pattern Memory associated with them is recoverable and reusable.

It is straightforward to provide data in the cascade signal to indicate packets or partial packets that are already being identified and some sort of packet identification for use in later ordering of determined processed packets within the cascade signal. This is typically done by over-clocking the inter-module signal or by culling the data signal to remove unnecessary data therein in order to provide the additional space for the inserted data. Of course, since each engine introduces a delay into the circuit (latency), the same could be accomplished using delay lines of different duration all coupled to the received data. Unfortunately in a straightforward parallel implementation, the number of loads on the Receive data lines is substantial and may result in excessive noise for proper circuit operation. Therefore, it is preferred to pass the data along from engine to engine in order to match delays and to maintain a one to one relationship between driver and load on the Receive data lines.

Since all packet processing cores within each module operate on processing data in parallel and each module operates in parallel to the other modules, the performance cost of the above circuit is the latency introduced by the cascading of different modules. Of course, the modules cascaded may each be either a plurality of parallel packet processing cores. Preferably, each plurality of cores is implemented in a single integrated circuit (IC) forming a module and thus the implemented processor is a plurality of interconnected chips.

As is evident to those of skill in the art, unless the data latency is substantial or unless bidirectional communication of small packets one in response to another is commonplace, data latency is not a significant concern.

The Received data passed from module to module includes data inserted by the previous modules indicative of identification and so forth. Such an implementation eliminates a need to provide an extra signal path between modules and is therefore a more efficient use of module ports and may be significantly advantageous when a module is implemented within an ASIC depending on the number of available output pins. Though such an implementation adds further latency to the engine, it has been found that this latency is not significant for most applications. When latency reduction is desired, it is possible to strip out data relating to packets processed by any upstream modules or overclock the output ports thereof. Then, the additional information occupies unused space within the stream. Of course, the data must finally be assembled and therefore, such an implementation may suffer from other disadvantages not addressed herein.

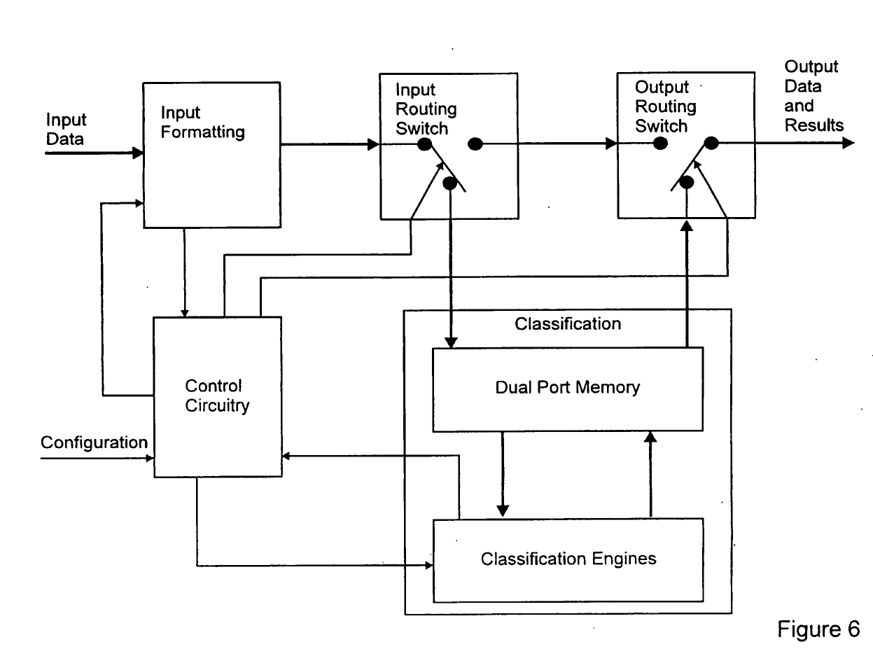

A block diagram of a single integrated circuit incorporating a number of packet processing cores and a data memory is shown in FIG. 6. The data memory is shown as a dual ported memory. The processing cores are arranged in parallel and each has access to the data memory to extract data for use in processing.

The received data is provided to an input formatting block. Here the received data is provided with ordering information when same is not present. Of course, downstream integrated circuits will not need to format the received data. Alternatively, partial formatting is performed at each stage. In the preferred embodiment, the input formatting block uniquely marks each input packet and reformats the data from the standard POSPHY PL4 format to a proprietary (over sized bus) format in preparation for routing through the cascade or processing. This block also provides the POSPHY PL4 related functions. It also provides necessary information to control circuitry for routing control. And finally inserts a unique packet identity tag generated by the control circuitry within the data stream and associated with each packet.

Once the data is formatted, it is provided to an input routing switch. As shown in the diagram, data for processing by a module is provided to the buffer from the input routing switch of that module. The input routing switch determines packets for processing by the present integrated circuit. Of course, when it is the only integrated circuit, all packets are routed to the buffer. The packets are also routed to an output routing switch. Optionally, the input routing switch passes only data not provided to the dual port memory to the output routing switch. Typically, since packet processing of some packets occurs within the module, the processing data that is determined through the processing process is inserted within the data stream associated with the packet.

In the embodiment shown in FIG. 3, the packet data buffer is in the form of dual port memory. Preferably, this is achieved by using two memory buffers that have all their input ports coupled such that they each have identical data therein but such that each of two output ports—one for each data memory—is independently accessible by circuits such as the classification core and the packet transmit controller. As such, the buffer behaves similarly to a dual port memory without requiring complex faster memory circuitry.

Of course, due to additional data within the data stream, there will be times when a considerable amount of data may be buffered. This is easily determined through simulations, and design choices relating to bus speed and memory storage size are straightforward methods of avoiding a possibility of data overflow.

According to a preferred embodiment of the invention each module comprises 16 processing cores. This number is selected since its implementation within a single integrated circuit is possible. Of course other numbers of processing cores are also possible. The 16 processing cores process packet data stored in the dual port memory to a predefined set of protocol/data patterns and generate a unique user defined tag associated with each packet or packet segment in the form of a prefix.

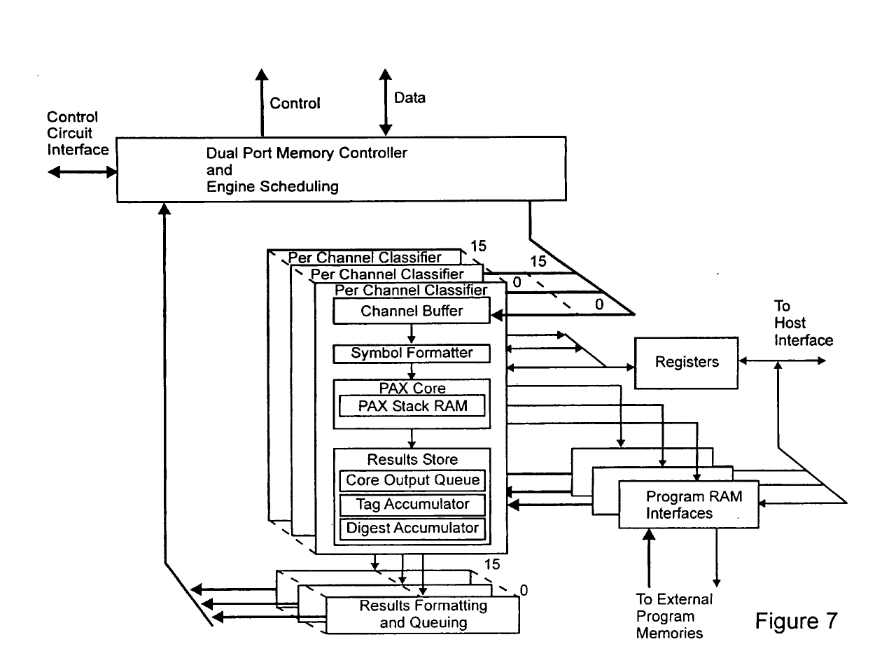

Referring to FIG. 7, a channel processor is responsible for accepting packet data, port information, and other control information and storing it in a channel buffer from dual port memory interface. The data is then passed from the channel buffer to a symbol formatter. The symbol formatter converts these 16 bits into programmable sized symbols. The symbols are then passed from the symbol formatter block into a packet processing core in the form of a processing core. The processing core uses these symbols to carry out processing and produce tag and digest results. The tag and digest results are accumulated in the results store and made available to a results formatting and queuing block. After output formatting is completed the results tag and the digest are preappended to the corresponding packet fragment in dual port memory.

In an exemplary embodiment, a 32 bit value, not hard encoded in any instruction, is used as the processing result tag. It is accumulated (built up) during processing processing. Up to 16 adjacent bits of the tag value are specified or modified per state or processor cycle. Up to 16 bits of the Tag are set by each instruction including the Stop instruction. This permits setting the tag value after the processing decision has been finalised. A powerful use of this accumulated tag is to incrementally specify parts of the tag value as incremental decisions about the processing are made. Provision exists to alter tag bits previously set, and so decisions can be reworked when necessary. These two features permit a significant reduction in pattern memory storage requirements. The tag mechanism also provides the control to increment the Processing Counters. The incremental tag accumulation permits making a decision to increment several counters during processing and later revoke that decision if a Reject processing decision is the final conclusion of the processing process.

A results formatting block is shown between the per channel processors and the internal dual port memory. It provides the logic that translates raw 128 bits of core output queue into two 64-bit segments ready to be preappended to packets in dual port memory.

Of course, other processing cores are useful with the circuit of the present invention.

Though in the above description, the processor is shown for processing of similar packet data, this need not be the case. It is possible to process data from different streams and to process different data using different processing state machine programming. Since processing and order of packets is of concern within a scope of a single stream of data, the output buffer control is simplified in maintaining an order of output data values consistent within each stream.

Further, the architecture of the present invention supports operation of a device comprising processors having different processing capabilities. The method of load balancing described above will function with different processors such that a newer processor having better performance can be added to a system employing earlier generation processors according to the invention. The new processor will provide enhanced performance of the overall system. This is highly advantageous in scalable systems wherein replacement of old equipment can be costly and, when unnecessary, should be avoided.

Alternatively, the above architecture is applied to processing of data other than packet processing. The serial parallel processor of the present invention is applicable to any segmentable processing wherein there is no history beyond a segment. Because it restores an order of processed data according to an order of incoming data at an output port of the device, it is useful in many processing operations wherein processing ability is important. It is extremely well suited for segments having varying lengths wherein the order of arrival of segment data is not predictable. Because of the load balancing inherent in the architecture, the invention is well suited to support even complex processing functions.

Advantageously, because of the architecture described above, the processors are preferably fully symmetric requiring addressing information for programming thereof only. As such, once programmed, the processors are not addressed and operate in-line through a cascading mechanism. The processed data is sequenced once processed in order to provide output data in a desired sequence. The data arriving at the input port of the first processor is reformatted and segmented there. All other processors are freed of the reformatting and segmentation tasks. As such, within the serial array of in-line processors, there is little distinction between the nth processor and the n+1^{st} processor so long as neither are the first or last processor. Also, no processor needs information relating to its placement in-line unless it is a first or last processing element. This makes addition of further processors a simple matter.

Numerous other embodiments of the invention are envisioned without departing from the spirit or scope of the invention.

1. A packet processing module comprising:
an input port;
a data input circuit for receiving a stream of input data provided at the input port and for determining sequencing information relating to packets within the stream;
a plurality of packet processing cores for receiving stream data from the data input circuit, for processing the buffered stream data relating to a single packet, and for providing processing data relating to the single packet; and
an output routing switch for receiving the processing data from the packet processing core and for providing the processing data at an output port thereof with data determined based on the sequencing information determined by the data input circuit.

2. A packet processing module according to claim 1, wherein the packet processing core comprises:
a processor; and,
a data memory for buffering data for provision from the data input circuit to the processor.

3. A packet processing module according to claim 2, wherein a single packet processing core is for accessing the data memory and another packet processing core is for accessing different data memory.

4. A packet processing module according to claim 1, comprising an output buffer for buffering data for provision from the output routing switch.

5. A packet processor module for use with other similar packet processing modules comprising:
an input port;
a data formatting circuit for receiving a stream of input data from upstream the module and received at the input port and for uniquely identifying each input packet;
data memory for receiving data and for storing the data;
a packet processing core for receiving data from the data memory, for processing the received data relating to a single packet, and for providing processing data relating to the single packet;
an input routing switch for routing data contained within the stream relating to packets to be processed by the packet processing core;
an output routing switch for routing data within the stream and further data provided by the packet processing core downstream of the module.

6. A packet processor module according to claim 5, wherein the input formatting circuit for uniquely identifying packets is for identifying packet sequence and comprises means for providing data associated with each packet and indicative of the packet's sequence within the data stream.

7. A packet processor module according to claim 6, wherein the input formatting circuit comprises means for reformatting the received data.

8. A packet processor comprising at least a first module according to claim 4 and at least a second module according to claim 5, the second module logically downstream of the first module for receiving a stream of data provided by the output routing switch of the first module to the input port of the second module.

9. A packet processor comprising at least a first module according to claim 5 and at least a second module according to claim 5, the second module logically downstream of the first module for receiving a stream of reformatted data and processed data provided from upstream via the output routing switch of the first module to the input port of the second module.

10. A packet processor module according to claim 5, wherein the module comprises means for determining whether to process a particular packet or to pass said packet downstream, the means dependent upon a load upon the module.

11. A packet processor module according to claim 5, wherein the module comprises means for determining whether to process a particular partial packet or to pass said partial packet downstream, the means dependent upon data relating to packets currently being processed by said module.

12. A packet processor module according to claim 5, wherein the module comprises at least another packet processing core for receiving data from the data memory, for processing the received data relating to a single packet, and for providing processing data relating to the single packet.

13. A packet processor comprising:
an input port;
a plurality of packet processing sub-engines each comprising:
a data input buffer coupled to the input port and for receiving a stream of input data and for buffering data within the stream relating to packets to be processed by the sub-engine,
a packet processing core for receiving buffered stream data from the data input buffer, for processing the buffered stream data relating to a single packet, and for providing processing data relating to the single packet, and
an output buffer for receiving the processing data, for buffering the received processing data, and for providing the buffered data at an output port thereof in response to an output control signal;
an input buffer controller for providing control signals to the input buffers from different packet processing sub-engines, the signals indicative of packets for buffering and processing by each packet processing sub-engine; and,
an output buffer controller for providing the output control signals to the output buffers from different packet processing sub-engines.

14. A packet processor as defined in claim 13, wherein each data input buffer is coupled to a same data input port.

15. A packet processor as defined in claim 14, comprising an output port and wherein the output buffers are coupled to the output port and the output buffer controller comprises means for controlling the output buffers to ensure that processing data provided at the output port is provided in an order corresponding to the order in which the packets occur within a data stream received at the input port.

16. A packet processor as defined in claim 15, comprising a multiplexer responsive to a signal from the output buffer controller for multiplexing processing data from the output buffers into a same output signal.

17. A packet processor as defined in claim 13, comprising a multiplexer responsive to a signal from the output buffer controller for multiplexing processing data from the output buffers into a same output signal, the multiplexed processing data forming a merged output signal including processing data from each of the plurality of processors.

18. A packet processor as defined in claim 15, wherein the input buffer controller is responsive to a packet start/end signal provided by an external circuit.

19. A packet processor as defined in claim 18, wherein the input buffer controller comprises means for balancing a data load between a plurality of input buffers.

20. A packet processor as defined in claim 19, wherein the input buffer controller comprises data storage for storing an indication of an input buffer that is sufficiently available to receive data forming part of a subsequent packet.

21. A packet processor as defined in claim 20, wherein the input buffers comprise means for determining memory usage therewithin and for providing a signal to the input buffer controller indicative of said memory usage.

22. A packet processor as defined in claim 19.
wherein the input buffers comprise means for determining memory usage therewithin and for providing a signal to the input buffer controller indicative of said memory usage; and,
wherein the input buffer controller comprises means for receiving the signal and for determining at least an input buffer having available memory therein and comprising data storage means for storing an indication of the determined input buffer.

23. A packet processor as defined in claim 13, wherein the input buffers operate at a first bandwidth and the packet processing cores operate at a second slower bandwidth.

24. A packet processor as defined in claim 13, comprising a second input port for receiving a second data input stream, wherein some input buffers are coupled to the second input port for receiving the second data input stream, the input buffer controller comprising means for selecting between the first data stream and the second data stream for provision to one of the some input buffers.

25. A packet processor comprising:
a plurality of packet processing cores, each for receiving buffered stream data, for processing a packet within the buffered stream data provided to the packet processing core, and for providing processing data relating to the processed packet;
a data input buffer for receiving a stream of input data, for buffering data within the stream relating to packets to be processed by the packet processor, for determining a packet processing core from the plurality of packet processing cores having available bandwidth, and for providing the buffered stream data to the determined packet processing core from the plurality of packet processing cores;
an output buffer for receiving the processing data from each of the packet processing cores and for providing the processing data at an output port thereof in an order similar to that in which the packets are received within the input data stream.

26. A packet processor comprising:
a packet processing module for operation in a master mode and in a slave mode and including:
at least a packet processing sub-engine comprising:
a data input buffer for receiving a stream of input data and for buffering data within the stream relating to packets to be processed by the sub-engine,
a packet processing core for receiving buffered stream data from the data input buffer, for processing the buffered stream data relating to a single packet, and for providing processing data relating to the single packet, and,
an output buffer for receiving the processing data and for buffering the received processing data and for providing the buffered data at an output port thereof in response to a control signal;
an input buffer controller for, in the master mode, providing control signals to the input buffers from another packet processing module in communication with the packet processing module, the signals indicative of packets for buffering and processing by the other packet processing module; and,
an output buffer controller for, in the master mode, providing the control signals to the output buffers from another packet processing module in communication with the packet processing module.

27. A packet processor as defined in claim 26, wherein in the slave mode the input buffer controller and the output buffer controller are disabled.

28. A packet processor as defined in claim 26, wherein in the slave mode the input buffer controller and the output buffer controller provide control signals to the input buffers and to the output buffers respectively, in dependence upon control signals received from the master input buffer controller and master output buffer controller, the control signals provided to buffers on a same module as the slave controllers.

29. A packet processor as defined in claim 26, comprising two similar packet processing sub-engines wherein the sub-engines are programmable and including a program memory for storing a single instance of program data for use by the two different packet processing cores in parallel.

30. A method of packet processing comprising the steps of:
a) providing an input data stream;
b) providing a packet identification signal indicative of a presence or absence of a packet at a present location within the input data stream;
c) providing a plurality of input buffers each for buffering data within the input data stream;
d) determining an input buffer from the plurality of input buffers having available memory for buffering a packet subsequently received;
e) when the packet identification signal is indicative of data relating to a packet at a present stream location, enabling the determined buffer to buffer the input data stream until the packet identification signal is indicative of the end of the packet;
f) repeating steps (d) and (e);
d1) retrieving buffered data from an input buffer and processing the data using a packet processing sub-engine to provide a processing result;
d2) buffering the processing result;
d3) providing the processing result within an output signal in a sequence identical to the sequence in which the packet to which the processing result relates was received in the input data stream.

31. A method of packet processing as defined in claim 30, comprising the step of providing a second input data stream,
providing a second output signal,
wherein the input data stream and the second input data stream are processed in parallel using a same program memory, same input buffers, and same output buffers.

32. A method of performing load balancing in a serially connected parallel processor system comprising the steps of:
determining for a first processor an indication of a current load on said processor, the indication having a plurality of possible values;
providing the determined indication of current load to a second processor upstream of the first processor;
receiving the determined indication of current load from the first processor at the second processor;
determining for the second processor a second indication of a current load on said processor, the indication having a plurality of possible values;
comparing the indication to the second indication; and,
when the indication is indicative of a higher load than the second indication, accepting the next packet for processing by the second processor.

33. A method as defined in claim 32, comprising the step of:
providing the indication indicative of a lighter load from the indication and the second indication to a third processor upstream of the second processor.

34. A method as defined in claim 32, wherein each of a plurality of processors has stored therein an indication to accept an upcoming packet or to pass it downstream, the indication determined by comparing a determined indication of current load of said processor to an indication received by said processor from downstream of said processor.

35. A method of processing segmented data using in-line processors comprising the steps of:
a) providing an input data stream;
b) providing a segment identification signal indicative of a presence or absence of a data segment at a present location within the input data stream;
c) reformatting data within the input data stream;
d) providing the reformatted data to a current processor input switch;
e) determining based on load data of the current processor and load data received from downstream of the processor whether to buffer the data for processing or to provide the data at an output port of the current processor and performing the determined function;
f) repeating steps (d) and (e) for each of a plurality of processors until the data is buffered or until the data reaches the most downstream processor; and,
g) sequencing and reformatting processed data for provision to an output switch of the most downstream in-line processor.

36. A method of processing segmented data using in-line processors according to claim 35, wherein the data segment is a packet.

37. A method of processing segmented data using in-line processors according to claim 36 wherein the in-line processors are each a same processor.

38. A method of processing segmented data using in-line processors according to claim 35, wherein the step (g) of reformatting is performed only by the most downstream of the in-line processors.

39. A method of processing segmented data using in-line processors according to claim 38, wherein the step (g) of sequencing is performed by each processor in-line.

40. A method of processing segmented data using in-line processors according to claim 35, wherein the load data is indicative of a lighter load existing downstream of a processor or of an absence of lighter loads downstream of the processor.

41. A parallel data processing engine module for use in processing of segmented data with other similar data processing engine modules comprising:
an input port;
a data formatting circuit for receiving a stream of input data from upstream the module and received at the input port and for uniquely identifying each input data segment;
data memory for receiving data and for storing the data;
a processing core for receiving data from the data memory, for processing the received data relating to a single segment according to predetermined processing, and for providing processing result data relating to the single segment;
an input routing switch for routing data contained within the stream relating to segments to be processed by the processing engine;
an output routing switch for routing data within the stream and further data provided by the processing engine downstream of the module.
